(19) United States
(12) Patent Application Publication
(10) Pub. No.: US 2025/0373813 A1
(43) Pub. Date: Dec. 4, 2025

(54) METHOD AND APPARATUS FOR PROCESSING CODEC PERFORMANCE METRIC, MEDIUM, AND ELECTRONIC DEVICE

(71) Applicant: Tencent Technology (Shenzhen) Company Limited, Shenzhen (CN)

(72) Inventor: Haiqiang WANG, Shenzhen (CN)

(21) Appl. No.: 19/305,629

(22) Filed: Aug. 20, 2025

Related U.S. Application Data
(63) Continuation of application No. PCT/CN2024/098815, filed on Jun. 13, 2024.

(30) Foreign Application Priority Data
Jun. 21, 2023 (CN) 202310747790.9

(51) Int. Cl. H04N 19/146; H04N 19/164

(52) U.S. Cl. CPC H04N 19/146; H04N 19/164

(57) ABSTRACT

This application provide a method for processing a codec performance metric performed by an electronic device. The method includes: obtaining a plurality of pieces of relationship data between a specified codec performance metric and a bitrate; obtaining a monotonic target function set for the specified codec performance metric and the bitrate, the target function including a plurality of parameters for representing a shape of a function curve; determining values of the plurality of parameters based on the plurality of pieces of relationship data and the target function; and determining a nonlinear relationship between the specified codec performance metric and the bitrate based on the target function and the plurality of parameters.

### CROSS-REFERENCE TO RELATED APPLICATIONS

This application is a continuation application of PCT Patent Application No. PCT/CN2024/098815, entitled “METHOD AND APPARATUS FOR PROCESSING CODEC PERFORMANCE METRIC, MEDIUM, AND ELECTRONIC DEVICE” filed on Jun. 13, 2024, which claims priority to Chinese Patent Application No. 2023107477909, entitled “METHOD AND APPARATUS FOR PROCESSING CODEC PERFORMANCE METRIC, MEDIUM, AND ELECTRONIC DEVICE” filed with the China National Intellectual Property Administration on Jun. 21, 2023, both of which are incorporated by reference in their entirety.

### FIELD OF THE TECHNOLOGY

This application relates to the field of computer and communication technologies, and specifically, to a method and an apparatus for processing a codec performance metric, a medium, and an electronic device.

### BACKGROUND OF THE DISCLOSURE

During development of multimedia codecs, it is common to compare performance of different codecs. For example, Bjontegaard Delta PSNR (BD-PSNR) is used to measure an average peak signal to noise ratio (PSNR) gain under the same bitrate condition, and Bjontegaard Delta Rate (BD-Rate) is used to measure an average bitrate gain at the same quality. In the related art, when a plurality of data points for representing a relationship between PSNR and Rate are obtained, it is common to obtain a relationship curve between PSNR and Rate by performing interpolation between the plurality of data points. However, this method may introduce significant deviations for non-monotonic data points, making it difficult to accurately measure the performance of the codec. Moreover, interpolation can only be used to compare overlapping parts in relationship curves corresponding to different codecs, leading to significant randomness in comparison results.

### SUMMARY

Embodiments of this application provide a method and an apparatus for processing a codec performance metric, a medium, and an electronic device, so that the performance of a codec can be measured through a monotonic nonlinear relationship, and performance comparison within any interval can also be supported through an obtained nonlinear relationship, thereby improving the accuracy and flexibility of codec performance metric measurement.

Another feature and advantage of this application is apparent from the following detailed description, or may be learned partially by practice of this application.

According to an aspect of the embodiments of this application, a method for processing a codec performance metric is performed by an electronic device. The method includes: obtaining a plurality of pieces of relationship data between a specified codec performance metric and a bitrate; obtaining a monotonic target function set for the specified codec performance metric and the bitrate, the target function including a plurality of parameters for representing a shape of a function curve; determining the plurality of parameters based on the plurality of pieces of relationship data and the target function; and determining a nonlinear relationship between the specified codec performance metric and the bitrate based on the target function and the plurality of parameters.

According to an aspect of the embodiments of this application, a non-transitory computer-readable medium is provided. The computer-readable medium has a computer program stored therein, the computer program, when executed by a processor of an electronic device, causing the electronic device to implement the method for processing a codec performance metric according to the foregoing embodiments.

According to an aspect of the embodiments of this application, an electronic device is provided. The electronic device includes one or more processors and a storage apparatus configured to store one or more computer programs, the one or more computer programs, when executed by the one or more processors, causing the electronic device to implement the method for processing a codec performance metric according to the foregoing embodiments.

The foregoing general descriptions and the following detailed descriptions are only illustrative and explanatory, and do not limit this application.

### BRIEF DESCRIPTION OF THE DRAWINGS

FIG. 1 is a schematic diagram of an exemplary system architecture to which the technical solutions of the embodiments of this application are applicable.

FIG. 2 is a schematic diagram of a placement manner of a video encoding device and a video decoding device in a streaming transmission system.

FIG. 3 is a schematic diagram of a relationship curve between a bitrate and a performance metric according to an embodiment.

FIG. 4 is a schematic diagram of distribution of relationship data between a bitrate and a performance metric according to an embodiment.

FIG. 5 is a flowchart of a method for processing a codec performance metric according to an embodiment of this application.

FIG. 6 is a flowchart of a method for evaluating a video codec according to an embodiment of this application.

FIG. 7 is a schematic curve diagram of a target function according to an embodiment of this application.

FIG. 8 is a flowchart of solving a parameter in a target function according to an embodiment of this application.

FIG. 9 is a schematic diagram of a relationship curve between a bitrate and a performance metric according to an embodiment of this application.

FIG. 10 is a schematic diagram of a relationship curve between a bitrate and a performance metric according to an embodiment of this application.

FIG. 11 is a block diagram of an apparatus for processing a codec performance metric according to an embodiment of this application.

FIG. 12 is a schematic structural diagram of a computer system suitable for implementing the electronic device according to the embodiments of this application.

### DESCRIPTION OF EMBODIMENTS

Example implementations are described in a more comprehensive manner with reference to the drawings. However, the example implementations may be implemented in various manners, and cannot be understood as limited to these examples. On the contrary, an objective of these implementations is provided to make this application more comprehensive and complete, and fully conveys concepts of the example implementations to a person skilled in the art.

In addition, features, structures, or characteristics described in this application may be combined in any appropriate manner in any one or more embodiments. In the following description, a plurality of specific details are provided to provide a fully understanding of embodiments of this application. However, a person skilled in the art may understand that when implementing the technical solutions of this application, not all detailed features in embodiments may be used, one or more specific details may be omitted, or another method, component, apparatus, operation, and the like may be used.

Block diagrams shown in the figures are functional entities only and do not necessarily correspond to physically separate entities. To be specific, these functional entities may be implemented in a form of software, or these functional entities may be implemented in one or more hardware modules or integrated circuits, or these functional entities may be implemented in different networks and/or processor apparatuses and/or microcontroller apparatuses.

Flowcharts shown in the drawings are only examples for description, do not necessarily include all contents and operations/steps, and are not necessarily executed in a described sequence. For example, some operations/steps may also be decomposed, and some operations/steps may be merged or partially merged, so an actual sequence of execution may change based on an actual situation.

The “plurality” mentioned in this disclosure refers to two or more. The term “and/or” in this specification is an association relationship for describing associated objects, and represents that three relationships may exist. For example, A and/or B may represent the following three cases: Only A exists, both A and B exist, and only B exists. The character “/” generally indicates an “or” relationship between the associated objects.

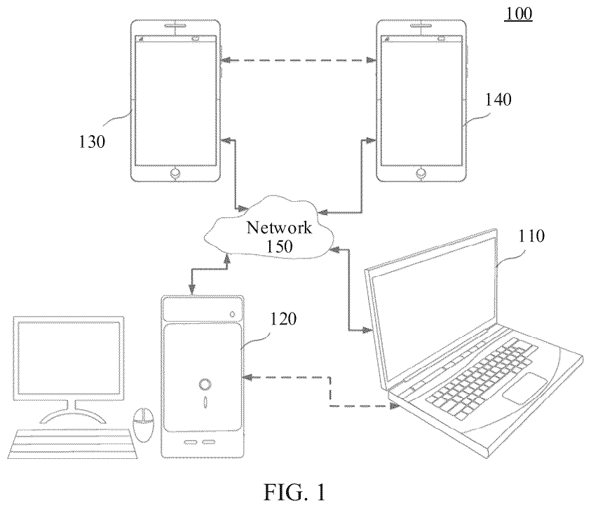

The technical solutions in the embodiments of this application may be applied to a video codec scenario. For example, an exemplary system architecture shown in FIG. 1 includes a plurality of terminal devices, and the terminal devices may communicate with each other through, for example, a network 150. For example, the system architecture 100 may include a first terminal device 110 and a second terminal device 120 that are interconnected through the network 150. In the embodiment of FIG. 1, the first terminal device 110 and the second terminal device 120 perform unidirectional data transmission.

For example, the first terminal device 110 may encode video data (for example, a video image stream captured by the terminal device 110) for transmission to the second terminal device 120 through the network 150, where the encoded video data is transmitted in a form of one or more encoded video bitstreams, and the second terminal device 120 may receive the encoded video data from the network 150, decode the encoded video data to recover the video data, and display a video image based on the recovered video data.

In an embodiment of this application, the system architecture 100 may include a third terminal device 130 and a fourth terminal device 140 that perform bidirectional transmission of encoded video data. The bidirectional transmission may occur, for example, during a video conference. For the bidirectional data transmission, each of the third terminal device 130 and the fourth terminal device 140 may encode the video data (for example, the video image stream captured by the terminal device) for transmission to the other terminal device of the third terminal device 130 and the fourth terminal device 140 through the network 150. Each of the third terminal device 130 and the fourth terminal device 140 may further receive the encoded video data transmitted by the other of the third terminal device 130 and the fourth terminal device 140, decode the encoded video data to recover the video data, and display the video image on an accessible display apparatus based on the recovered video data.

In the embodiment of FIG. 1, the first terminal device 110, the second terminal device 120, the third terminal device 130, and the fourth terminal device 140 may be servers, personal computers, and smartphones. However, the principles disclosed in this application may not be limited thereto. The embodiments disclosed in this application are applicable to a laptop computer, a tablet computer, a media player, and/or a dedicated video conference device. The network 150 represents any number of networks for transmitting the encoded video data between the first terminal device 110, the second terminal device 120, the third terminal device 130, and the fourth terminal device 140, and includes, for example, a wired and/or wireless communication network. The communication network 150 may exchange data in a circuit switching and/or packet switching channel. The network may include a telecommunication network, a local area network, a wide area network, and/or the Internet. For the purpose of this application, unless explained below, an architecture and a topology of the network 150 may be inconsequential to operations disclosed in this application.

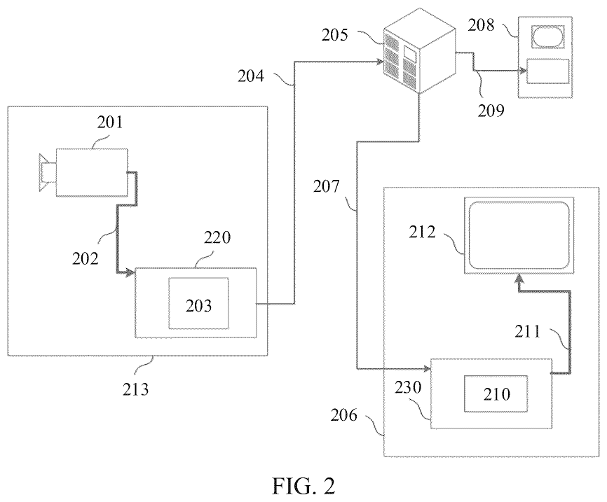

In an embodiment of this application, FIG. 2 shows a placement manner of a video encoding device and a video decoding device in a streaming transmission environment. The subject disclosed in this application may be equally applicable to other applications supporting a video, including, for example, a video conference, a digital television (TV), and a compressed video stored on a digital medium including a CD, a DVD, a storage stick, or the like.

A streaming transmission system may include a capture subsystem 213. The capture subsystem 213 may include a video source 201 such as a digital camera. The video source creates an uncompressed video image stream 202. In an embodiment, the video image stream 202 includes samples captured by the digital camera. Compared with encoded video data 204 (or encoded video bitstream 204), the video image stream 202 is depicted as a thick line to emphasize a video image stream with a high data volume. The video image stream 202 may be processed by an electronic device 220. The electronic device 220 includes a video encoding device 203 coupled to the video source 201. The video encoding device 203 may include hardware, software, or a combination of software and hardware to achieve or implement aspects of the disclosed subject described in more detail below. Compared with the video image stream 202, the encoded video data 204 (or the encoded video bitstream 204) is depicted as a thin line to emphasize the encoded video data 204 (or the encoded video bitstream 204) with a low data volume, and the encoded video data 204 may be stored on a streaming server 205 for future use. One or more streaming client subsystems, for example, a client subsystem 206 and a client subsystem 208 in FIG. 2, may access the streaming server 205 to retrieve a copy 207 and a copy 209 of the encoded video data 204. The client subsystem 206 may include, for example, a video decoding device 210 in an electronic device 230. The video decoding device 210 decodes the incoming copy 207 of the encoded video data, and generates an output video image stream 211 that may be displayed on a display 212 (for example, a display screen) or another display device. In some streaming transmission systems, the encoded video data 204, video data 207, and video data 209 (for example, a video bitstream) may be encoded according to some video encoding/compression standards.

The electronic device 220 and the electronic device 230 may include other components not shown in the figure. For example, the electronic device 220 may include the video decoding device, and the electronic device 230 may further include the video encoding device.

In all of the foregoing exemplary video codec scenarios, a multimedia codec needs to be used, and during the development of the multimedia codec, it is common to compare performance of different codecs through a codec performance metric. For example, Bjontegaard Delta PSNR (BD-PSNR) is used to measure an average peak signal to noise ratio (PSNR) gain under the same bitrate condition, and Bjontegaard Delta Rate (BD-Rate) is used to measure an average bitrate gain at the same quality.

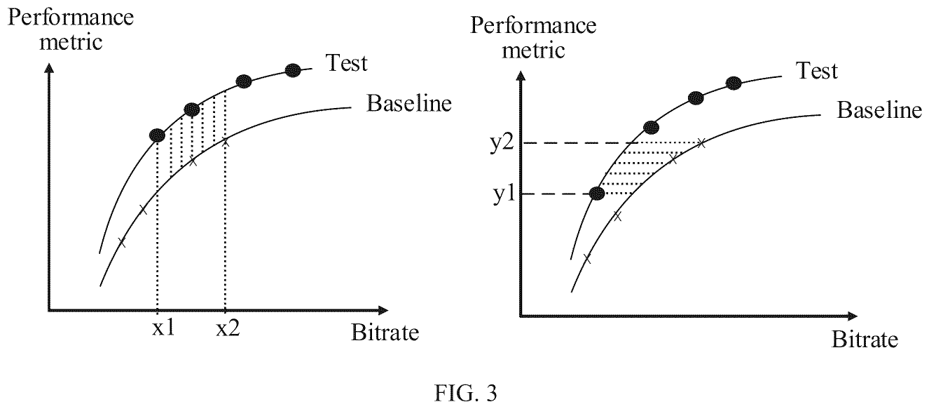

Specifically, as shown in FIG. 3, in a relationship between a performance metric (a PSNR is used as an example for description) and a bitrate, a test curve represents a PSNR curve and a bitrate curve corresponding to a test video codec, and a baseline curve represents a PSNR curve and a bitrate curve corresponding to a baseline video codec. As shown in the left figure in FIG. 3, within a bitrate range [x1, x2], interval integrals of the baseline curve and the test curve along a bitrate coordinate axis are calculated respectively, and denoted as Ga and Gt. An average PSNR gain of a test scheme (that is, the test video codec) relative to a baseline scheme (that is, the baseline video codec) under the same bitrate condition may be represented through a formula (Gt−Ga)/(x2−x1).

As shown in the right figure in FIG. 3, within a PSNR range [y1, y2], interval integrals of the baseline curve and the test curve along a performance metric coordinate axis are calculated respectively, and denoted as Ga′ and Gt′. The average bitrate gain of the test scheme (that is, the test video codec) relative to the baseline scheme (that is, the baseline video codec) under the same PSNR condition may be represented through a formula (Gt′−Ga′)/(y2−y1).

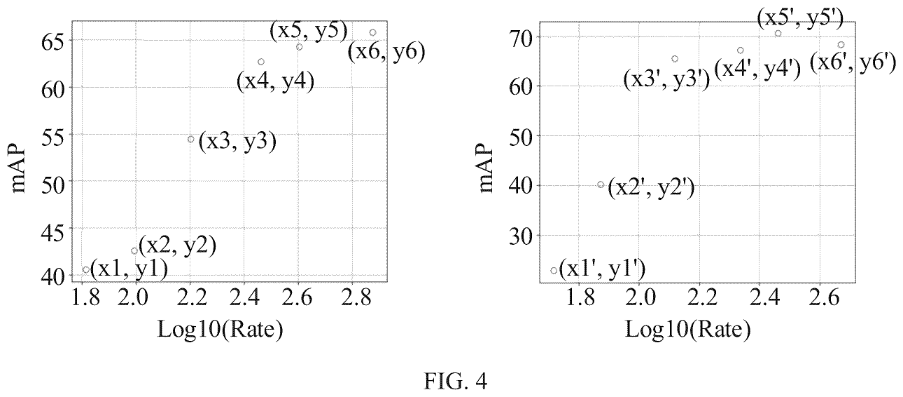

In the related art, when a plurality of data points for representing a relationship between the performance metric and Rate are obtained, it is common to obtain a relationship curve between the performance metric and Rate by performing interpolation between the plurality of data points. Specifically, a cubic function may be constructed according to a piecewise cubic hermit interpolation polynomial (PCHIP) algorithm by using a cubic hermit interpolation polynomial on every two adjacent points, and data between the two points is obtained through interpolation. For example, in data shown in the left figure in FIG. 4, six data points are used as input, and denoted as (x1, y1), (x2, y2), (x3, y3), (x4, y4), (x5, y5), and (x6, y6). Two points such as (x1, y1) and (x2, y2) are sequentially taken from left to right. An interpolation polynomial is solved through input values and the first-order derivative values of the two points. Then, points between x1 and x2 are solved through the interpolation polynomial. This process is repeated sequentially to obtain piecewise interpolation polynomials within an interval of x1 to x6, thereby obtaining the relationship curve between the performance metric and the bitrate.

Although the piecewise cubic hermit interpolation polynomial (PCHIP)-based algorithm in the related art can ensure monotonicity of an interpolation curve between two consecutive points, when input data is not monotonic, an average performance gain at the same bitrate and an average bitrate gain at the same quality cannot be calculated. This is because the premise of a calculation method of the average performance gain (for example, BD-PSNR) at the same bitrate and the average bitrate gain (for example, BD-Rate) at the same quality is that the data is monotonic. For example, in data shown in the right figure in FIG. 4, six data points are used as input, and denoted as (x1′, y1′), (x2′, y2′), (x3′, y3′), (x4′, y4′), (x5′, y5′), and (x6′, y6′). These data points are not monotonic. Therefore, in this case, the average performance gain at the same bitrate and the average bitrate gain at the same quality cannot be calculated according to the algorithm in the related art.

In addition, an evaluation interval of the algorithm in the related art when the average performance gain at the same bitrate and the average bitrate gain at the same quality are calculated needs to be an overlapping part (as shown in [x1, x2] and [y1, y2] in FIG. 3) of two groups of data. However, this interval occupies only a part of an entire data interval, which is not only unrepresentative, but also may significant deviations due to randomness.

Based on this, an embodiment of this application provides a new solution for processing a codec performance metric, so that the performance of the codec can be measured through a monotonic nonlinear relationship, and performance comparison in any range may also be supported through an obtained nonlinear relationship, thereby improving the accuracy and flexibility of codec performance metric measurement.

The following describes implementation of the technical solutions in detail in embodiments of this application.

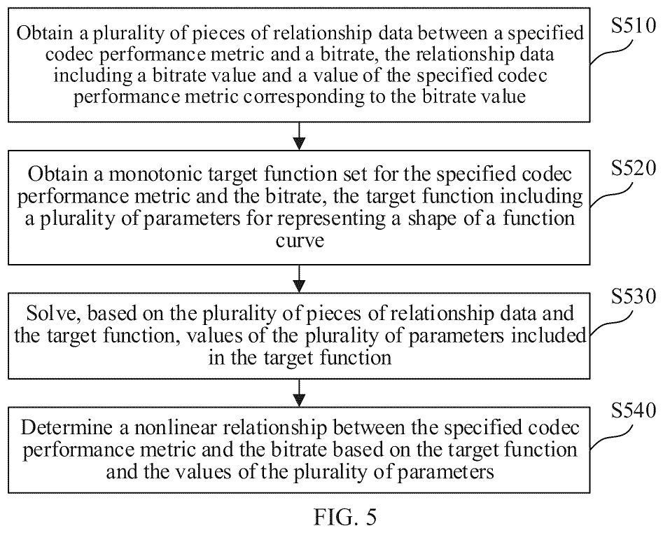

FIG. 5 is a flowchart of a method for processing a codec performance metric according to an embodiment of this application. The method for processing a codec performance metric may be performed by an electronic device. Referring to FIG. 5, the method for processing a codec performance metric includes at least operation S510 to operation S540, which are described in detail as follows.

Operation S510: Obtain a plurality of pieces of relationship data between a specified codec performance metric and a bitrate, the relationship data including a bitrate value and a value of the specified codec performance metric corresponding to the bitrate value.

In some embodiments, the specified codec performance metric may be a peak signal to noise ratio, mean average precision (mAP for short), multiple objects tracking accuracy (MOTA for short), encoding time, decoding time, or the like.

In some embodiments, the value of the specified codec performance metric corresponding to the bitrate value that is included in the relationship data may be a value of the specified codec performance metric corresponding to the bitrate value that is determined based on the bitrate value on a PSNR curve and a bitrate curve. Because the PSNR curve and the bitrate curve for representing the relationship between the specified codec performance metric and the bitrate may include a test curve and a baseline curve, the relationship data also correspondingly includes relationship data corresponding to a baseline codec and relationship data corresponding to a test codec.

In some embodiments, a process of obtaining a plurality of pieces of relationship data between a specified codec performance metric and a bitrate may be: encoding reference multimedia data separately by using a plurality of encoding parameters, to obtain encoded data corresponding to each encoding parameter; generating, based on an obtained bitrate statistic of each piece of encoded data and the value of the specified codec performance metric, relationship data corresponding to each piece of encoded data; and obtaining the plurality of pieces of relationship data based on the generated relationship data corresponding to each piece of encoded data. In some embodiments, the bitrate statistic of each piece of encoded data may be a bitrate average value, and the value of the specified codec performance metric of each piece of encoded data may also be an average value. The reference multimedia data may be a video, audio, an image, a point cloud, a three-dimensional mesh, or the like for evaluating the performance of the codec.

Operation S520: Obtain a monotonic target function set for the specified codec performance metric and the bitrate, the target function including a plurality of parameters for representing a shape of a function curve.

In some embodiments, the target function may be a logistic regression function, or may be another monotonic function. The plurality of parameters in the target function may include at least one of the following parameters: a first parameter for representing a maximum output value of the target function, a second parameter for representing a minimum output value of the target function, a third parameter for representing a translation amount of a function curve corresponding to the target function on a bitrate coordinate axis, and a fourth parameter for representing an intensity of variation of the function curve within a linear interval.

Operation S520 and operation S510 shown in FIG. 5 do not have a strict sequence. Operation S510 may be first performed, and then operation S520 may be performed based on the procedure shown in FIG. 5. Alternatively, operation S520 may be first performed, and then operation S510 is performed. Alternatively, operation S510 and operation S520 may be performed at the same time.

Operation S530: Solve, based on the plurality of pieces of relationship data and the target function, values of the plurality of parameters included in the target function.

In some embodiments, when the values of the plurality of parameters included in the target function are solved based on the plurality of pieces of relationship data and the target function, the values of the plurality of parameters may be initialized based on the plurality of pieces of relationship data, to obtain initial values of the plurality of parameters, and then the target function is fitted based on the initial values of the plurality of parameters and the plurality of pieces of relationship data, to obtain the values of the plurality of parameters through solving.

In some embodiments, when the values of the plurality of parameters are initialized based on the plurality of pieces of relationship data, a maximum value of the specified codec performance metric in the plurality of pieces of relationship data may be used as an initial value of the first parameter; a minimum value of the specified codec performance metric in the plurality of pieces of relationship data may be used as an initial value of the second parameter; an average value of the bitrate values included in the plurality of pieces of relationship data is used as an initial value of the third parameter; and a standard deviation of the bitrate values included in the plurality of pieces of relationship data is used as an initial value of the fourth parameter.

In some embodiments, a process of fitting the target function based on the initial values of the plurality of parameters and the plurality of pieces of relationship data, to obtain the values of the plurality of parameters through solving may be: fitting the target function based on the initial values of the plurality of parameters and the plurality of pieces of relationship data through the Newton method, the quasi-Newton method, an evolution method, a gradient descent method, and the like, to obtain the values of the plurality of parameters through solving.

Operation S540: Determine a nonlinear relationship between the specified codec performance metric and the bitrate based on the target function and the values of the plurality of parameters.

In some embodiments, the values of the plurality of obtained parameters may be substituted into the target function, to obtain the nonlinear relationship between the specified codec performance metric and the bitrate.

In some embodiments, if performance between the baseline codec and the test codec needs to be evaluated, a plurality of pieces of relationship data corresponding to the baseline codec and a plurality of pieces of relationship data corresponding to the test codec may be obtained based on the technical solutions of the foregoing embodiments. Specifically, for example, reference multimedia data may be separately encoded by using the plurality of encoding parameters through the baseline codec, to obtain encoded data corresponding to each encoding parameter, relationship data corresponding to each piece of encoded data is generated based on a bitrate statistic of each piece of encoded data and the value of the specified codec performance metric, and then the plurality of pieces of relationship data corresponding to the baseline codec are obtained based on the relationship data corresponding to each piece of encoded data.

For the test codec, the reference multimedia data may be separately encoded by using the plurality of encoding parameters through the test codec, to obtain the encoded data corresponding to each encoding parameter, the relationship data corresponding to each piece of encoded data is generated based on the bitrate statistic of each piece of encoded data and the value of the specified codec performance metric, and then the plurality of pieces of relationship data corresponding to the test codec are obtained based on the relationship data corresponding to each piece of encoded data.

After the plurality of pieces of relationship data corresponding to the baseline codec and the plurality of pieces of relationship data corresponding to the test codec are obtained, the first nonlinear relationship between the specified codec performance metric and the bitrate corresponding to the baseline codec may be determined based on the target function and the values of the plurality of parameters obtained through solving based on the plurality of pieces of relationship data corresponding to the baseline codec. In addition, the second nonlinear relationship between the specified codec performance metric and the bitrate corresponding to the test codec is determined based on the target function and the values of the plurality of parameters obtained through solving based on the plurality of pieces of relationship data corresponding to the test codec.

In some embodiments, the values of the plurality of parameters obtained through solving based on the plurality of pieces of relationship data corresponding to the baseline codec are substituted into the target function, to obtain the first nonlinear relationship between the specified codec performance metric and the bitrate corresponding to the baseline codec. The values of the plurality of parameters obtained through solving based on the plurality of pieces of relationship data corresponding to the test codec are substituted into the target function, to obtain the second nonlinear relationship between the specified codec performance metric and the bitrate corresponding to the test codec.

In some embodiments, after the first nonlinear relationship between the specified codec performance metric and the bitrate corresponding to the baseline codec and the second nonlinear relationship between the specified codec performance metric and the bitrate corresponding to the test codec are determined, an average gain of the specified codec performance metric of the test codec relative to the baseline codec under the same bitrate condition may be calculated based on the first nonlinear relationship, the second nonlinear relationship, and a set bitrate interval.

In some embodiments, a process of calculating an average gain of the specified codec performance metric of the test codec relative to the baseline codec under the same bitrate condition based on the first nonlinear relationship, the second nonlinear relationship, and a set bitrate interval may include: calculating, based on the first nonlinear relationship and the set bitrate interval, a first integral area of a function curve corresponding to the first nonlinear relationship within the set bitrate interval; calculating, based on the second nonlinear relationship and the set bitrate interval, a second integral area of a function curve corresponding to the second nonlinear relationship within the set bitrate interval; calculating an area difference between the second integral area and the first integral area; and calculating, based on the area difference and the bitrate interval, the average gain of the specified codec performance metric of the test codec relative to the baseline codec under the same bitrate condition. For example, the average gain of the specified codec performance metric of the test codec relative to the baseline codec under the same bitrate condition is obtained through a ratio of the area difference to a span (that is, a maximum value of the bitrate interval minus a minimum value of the bitrate interval) of the bitrate interval.

In some embodiments, after the first nonlinear relationship between the specified codec performance metric and the bitrate corresponding to the baseline codec and the second nonlinear relationship between the specified codec performance metric and the bitrate corresponding to the test codec are determined, an average bitrate gain of the test codec relative to the baseline codec under the same specified codec performance metric condition may be calculated based on the first nonlinear relationship, the second nonlinear relationship, and a set specified codec performance metric interval.

In some embodiments, a process of calculating, based on the first nonlinear relationship, the second nonlinear relationship, and a set specified codec performance metric interval, an average bitrate gain of the test codec relative to the baseline codec under the same specified codec performance metric condition may include: calculating, based on the first nonlinear relationship and the set specified codec performance metric interval, a third integral area of a function curve corresponding to the first nonlinear relationship within the set specified codec performance metric interval; calculating, based on the second nonlinear relationship and the set specified codec performance metric interval, a fourth integral area of a function curve corresponding to the second nonlinear relationship within the set specified codec performance metric interval; calculating an area difference between the fourth integral area and the third integral area; and calculating, based on the area difference and the set specified codec performance metric interval, the average bitrate gain of the test codec relative to the baseline codec under the same specified codec performance metric condition. For example, the average bitrate gain of the test codec relative to the baseline codec under the same specified codec performance metric condition is obtained through a ratio of the area difference to a span (that is, a maximum value of the set specified codec performance metric interval minus a minimum value of the set specified codec performance metric interval) of the set specified codec performance metric interval, to accurately measure the performance of the codec based on the obtained average bitrate gain under the same specified codec performance metric condition.

In the technical solutions in the embodiments of this application, the plurality of pieces of relationship data between the specified codec performance metric and the bitrate and the monotonic target function set for the specified codec performance metric and the bitrate are obtained, to solve, based on the plurality of pieces of relationship data and the target function, the values of the plurality of parameters included in the target function; and the nonlinear relationship between the specified codec performance metric and the bitrate is determined based on the target function and the obtained values of the plurality of parameters, so that no matter whether the relationship data between the specified codec performance metric and the bitrate is monotonic, a monotonic nonlinear relationship can be obtained through solving. Further, the performance of the codec can be measured through the monotonic nonlinear relationship, and performance comparison in any range can also be supported through the obtained nonlinear relationship, thereby improving the accuracy and flexibility of codec performance metric measurement.

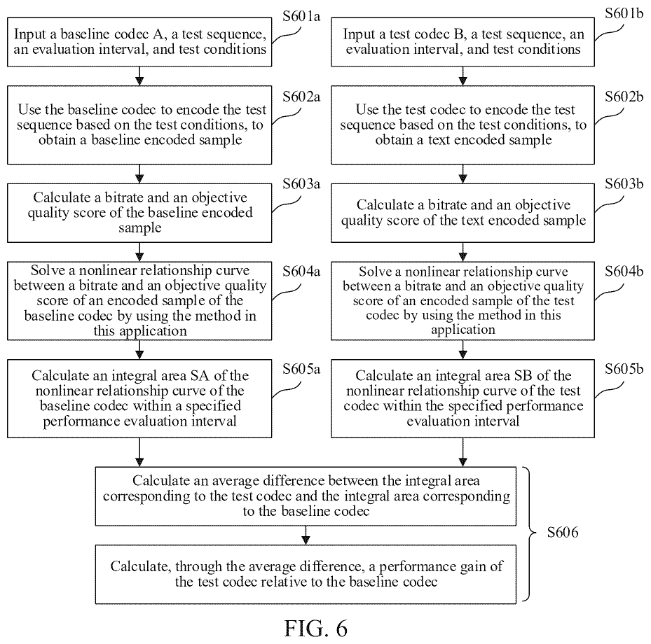

The following describes implementation details of the technical solutions in the embodiments of this application in detail with reference to FIG. 6 to FIG. 10 and by using evaluation of a video codec as an example.

Referring to FIG. 6, a method for evaluating a video codec according to an embodiment of this application includes the following operations.

Operation S601a: Input a baseline codec A, a test sequence, an evaluation interval, and test conditions. Operation S601b: Input a test codec B, a test sequence, an evaluation interval, and test conditions.

In some embodiments, the baseline codec A may be referred to as an anchor, and the test codec B may be referred to as a test. The test sequence is a reference video s, and one or more test sequences may be provided. The test conditions may be a group of encoding parameters [c1, c2, . . . , cn] and performance evaluation intervals [xa, xb] and [ya, yb]. If evaluation is performed by using two metrics: BD-PSNR and BD-Rate, a performance evaluation interval [xa, xb] represents a bitrate interval, and a performance evaluation interval [ya, yb] represents a PSNR interval.

Operation S602a: Use the baseline codec to encode a test sequence based on the test conditions, to obtain a baseline encoded sample. Operation S602b: Use the test codec to encode a test sequence based on the test conditions, to obtain a text encoded sample.

In some embodiments, for each encoding parameter in [c1, c2, . . . , cn], the anchor and the test may be used to encode s, to obtain two groups of encoded videos. One group is denoted as [sa1, sa2, . . . , san], and the other group is denoted as [st1, st2, . . . , stn]. san represents an encoded video obtained by encoding the reference video s by using the encoding parameter cn through the anchor, and stn represents an encoded video obtained by encoding the reference video s by using the encoding parameter cn through the test.

Operation S603a: Calculate a bitrate and an objective quality score of the baseline encoded sample. Operation S603b: Calculate a bitrate and an objective quality score of the test encoded sample.

In some embodiments, an average bitrate r and objective quality q of each encoded video may be calculated. Four groups of data are obtained, where [ra1, ra2, . . . , ran] is bitrate metrics of a video encoded by the anchor codec, [qa1, qa2, . . . , qan] is objective quality metrics (that is, PSNR values) of the video encoded by the anchor codec, [rt1, rt2, . . . , rtn] is bitrate metrics of a video encoded by the test codec, and [qt1, qt2, . . . , qtn] is objective quality metrics of the video encoded by the test codec.

By using the bitrate metric r (where r may be log10 (Rate)) as an x-axis, and the objective quality q as the y-axis, two groups of discrete points can be obtained. If some points between two groups of data have the same x-axis values, the comparison of their y-axis values may be used to determine which one is better. However, in an actual situation, it is difficult for the two groups of data to have some points that align on the x-axis or the y-axis. Therefore, in this embodiment of this application, each group of data obtained above may be used to fit nonlinear relationship curves of the anchor and the test through value solving, and then a quantitative comparison between the anchor and the test is performed based on this.

Operation S604a: Solve a nonlinear relationship curve fa(x) between a bitrate and an objective quality score of an encoded sample of the baseline codec by using the method in this application. Operation S604b: Solve a nonlinear relationship curve ft(x) between a bitrate and an objective quality score of an encoded sample of the test codec by using the method in this application.

In some embodiments, it is assumed that a rule between r and q is represented by using the following target function:

$$f ( x ) = a + \frac{b - a}{1 + {exp}^{[ - \frac{x - c}{\vert d \vert} ]}}$$

where a, b, c, and d are variables for controlling a curve shape, x is an input parameter (r in this example), and f (x) is an output value (objective quality q in this example). In some embodiments, a represents a maximum value of output, b represents a minimum value of output, c represents a horizontal translation amount of the entire curve on a bitrate coordinate axis, and d represents an intensity of variation of the function in an approximately linear interval.

Considering physical meanings of to-be-solved parameters, the following parameters may be used as initial values: a=max(yi), b=min(yi), c=avg(xi), and d=std(xi). In addition, to make a result obtained through fitting better match an actual value, the following parameter update limitations may be introduced: If yi represents PSNR, mAP, or MOTA, an iterative value range of a is limited to [max(yi), 100], and an iterative value range of b is limited to [0, min(yi)].

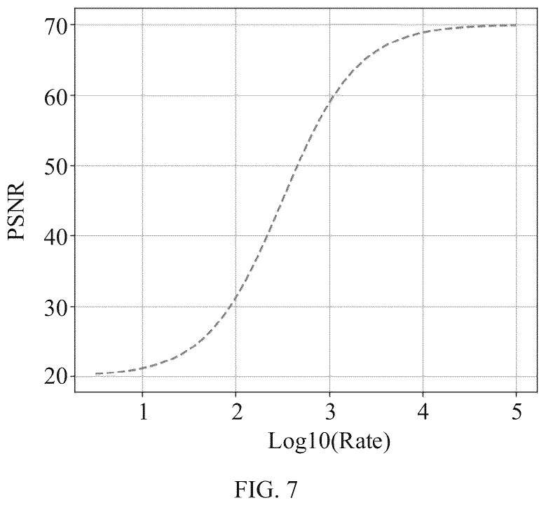

A target curve used in this embodiment of this application can better reflect the nonlinear relationship between the bitrate and the performance metric. Specifically, as shown in FIG. 7, FIG. 7 shows a curve used in this embodiment of this application. The curve has the following characteristics: (1) At a middle bitrate point, a performance metric presents a near-linear relationship with a bitrate, and as the bitrate increases, the performance metric also rapidly increases. (2) When the bitrate increases to a certain level, further increasing the bitrate may not necessarily bring additional performance metric gains, meaning that the performance metric enters a saturation region. (3) When the bitrate decreases to a certain level, the performance metric does not decrease as the bitrate decreases.

For the relationship data of the anchor, that is, [ra1, ra2, . . . , ran] and [qa1, qa2, . . . , qan], value fitting is performed based on the target function, to solve values of the parameters a, b, c, and d of the target function. The obtained values of the parameters a, b, c, and d are substituted into the equation of the target function, to obtain the nonlinear curve fa(x) corresponding to anchor data, that is, the first nonlinear relationship.

In an embodiment of this application, the values of a, b, c, and d may be solved by using a plurality of methods, such as the Newton method, the quasi-Newton method, and an evolution method. In an embodiment, by using a commonly used least squares estimation method as an example, this method may be implemented by minimizing the second-order distance between an input objective performance metric value and a fitted performance metric value, that is, solving is performed through the following formula:

$${min}_{a , b , c , and d} {\sum }_{i in [ 1 , 2 , … , n ]} {[ {y}_{i} - f ( {x}_{i} ) ]}^{2}$$

where yi represents a value of objective quality q corresponding to xi (that is, a bitrate metric), and f(xᵢ) represents an output value obtained by fitting through the target function when input is xi.

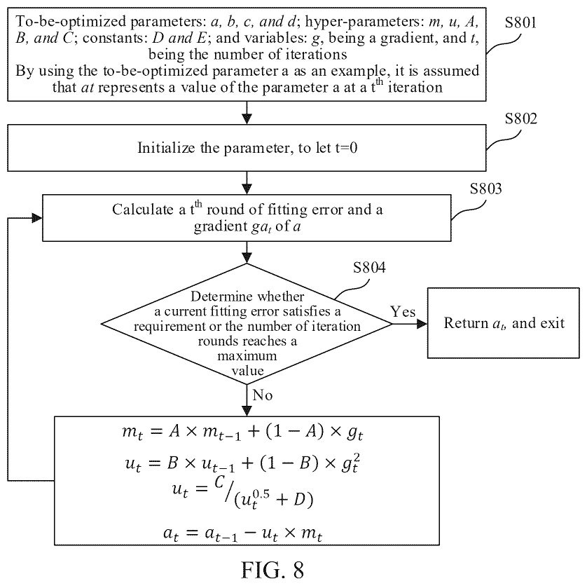

In an embodiment of this application, when values of a, b, c, and d are solved, a gradient descent method may also be used for solving. A specific process is shown in FIG. 8, and includes the following operations.

Operation S801: Determine to-be-optimized parameters: a, b, c, and d, where an optimization process involves hyper-parameters: m, u, A, B, and C; constants: D and E; and variables: g, being a gradient, and t, being the number of iterations. The to-be-optimized parameter a is used as an example to describe a process of solving a value of a. It is assumed that at represents a value of the parameter a at a t^{th} iteration.

Operation S802: Initialize the parameter, to let t=0.

Operation S803: Calculate a t^{th} round of fitting error and a gradient gaₜ of a.

Operation S804: Determine whether a current fitting error satisfies a requirement or the number of iterations reaches a maximum value. If the current fitting error satisfies the requirement or the number of iterations reaches the maximum value, return at as the value of a. If the current fitting error does not satisfy the requirement or the number of iterations does not reach the maximum value, perform the following assignment process, perform a next round of fitting, and then return to operation S803.

$${m}_{t} = A \times {m}_{t - 1} + ( 1 - A ) \times {g}_{t}$$

$${u}_{t} = B \times {u}_{t - 1} + ( 1 - B ) \times {g}_{t}^{2}$$

$${u}_{t} = C / ( {u}_{t}^{0.5} + D )$$

$${a}_{t} = {a}_{t - 1} - {u}_{t} \times {m}_{t}$$

A, B, and C may be initially set to respective corresponding preset values. In an iteration process, an attempt may be made to determine a group of values of A, B, and C with a minimum error as final values, D and E are preset constants, t is the number of iterations, mₜ and uₜ are respectively values of m and u in a t^{th} round of fitting process, and gₜ is a value of a gradient gaₜ of a in the t^{th} round of fitting process.

The function of

$${u}_{t} = C / ( {u}_{t}^{0.5} + D )$$

is to update uₜ, uₜ on the right of the equal sign is an old value, uₜ on the left of the equal sign is an updated value, and the updated value of uₜ is substituted into aₜ=aₜ₋₁−uₜ×mₜ, to calculate aₜ.

Similarly, for the test data, that is, [rt1, rt2, . . . , rtn] and [qt1, qt2, . . . , qtn], the corresponding nonlinear relationship curve ft(x), that is, the second nonlinear relationship, may also be obtained through the technical solutions of the foregoing embodiments.

Operation S605a: Calculate an integral area SA of the nonlinear relationship curve fa(x) of the baseline codec within a specified performance evaluation interval. Operation S605b: Calculate an integral area SB of the nonlinear relationship curve ft(x) of the test codec within the specified performance evaluation interval.

For example, if the performance evaluation interval is [xa, xb], the integral area SA of the nonlinear relationship curve fa(x) of the baseline codec within the specified test interval is

$${\int }_{x a}^{x b} fa ( x ) dx ,$$

and the integral area SB of the nonlinear relationship curve ft(x) of the test codec within the specified test interval is

$${\int }_{x a}^{x b} f t ( x ) d x .$$

Operation S606: Calculate an average difference between the integral area corresponding to the test codec and the integral area corresponding to the baseline codec, and calculate, through the average difference, a performance gain of the test codec relative to the baseline codec.

Specifically, for example, an average objective metric PSNR gain BD-PSNR of the test codec compared with the baseline codec at the same bitrate may be represented as:

$$B D - P S N R = \frac{1}{x b - x a} {\int }_{x a}^{x b} [ f t ( x ) - f a ( x ) ] d x$$

An average bitrate gain BD-Rate of the test codec compared with the baseline codec at the same PSNR may be represented as:

$$BD - rate = {10}^{\frac{1}{y b - y a} {\int }_{y a}^{y b} [ f t ( y ) - f a ( y ) ] d y} - 1$$

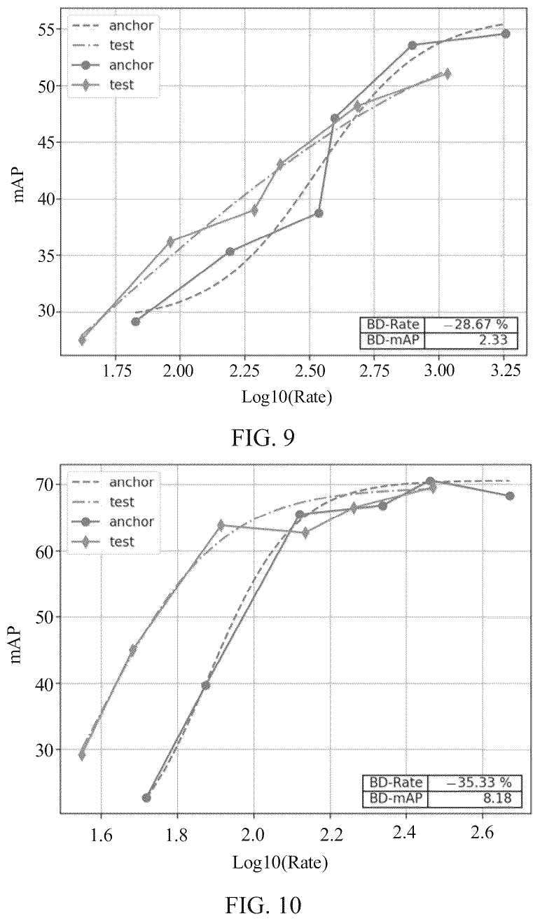

Based on the technical solutions of the embodiments of this application, as shown in FIG. 9 and FIG. 10, regardless of whether input data is monotonic (where data in FIG. 9 is monotonic, and data in FIG. 10 is not monotonic), in the technical solutions of the embodiments of this application, a monotonic target curve can be obtained through solving to evaluate a codec. Other performance metrics such as mAP, MOTA, encoding time, and decoding time may also be evaluated by using the technical solutions of the foregoing embodiments. In addition, the technical solutions in the embodiments of this application not only can be used to evaluate performance of a video codec, but also can evaluate codec performance of multimedia data such as audio, an image, a point cloud, and a three-dimensional mesh, to be applied to application scenarios such as iteration of codec versions, development of codec internal tools, and parallel comparison of codec performance.

The following introduces apparatus embodiments of this application, and may be configured to perform the method for processing a codec performance metric in the embodiments of this application. For details not disclosed in the apparatus embodiments of this application, refer to the method for processing a codec performance metric in the foregoing embodiments of this application.

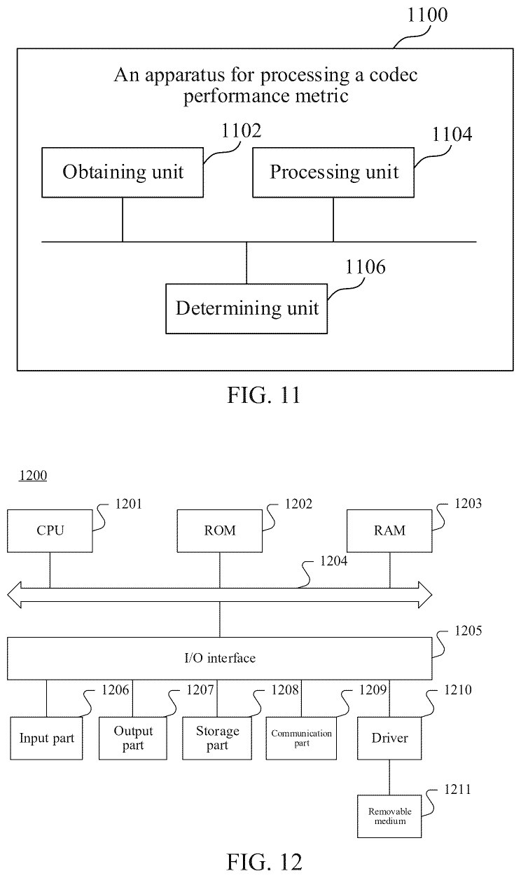

FIG. 11 is a block diagram of an apparatus for processing a codec performance metric according to an embodiment of this application.

Referring to FIG. 11, an apparatus 1100 for processing a codec performance metric according to an embodiment of this application includes an obtaining unit 1102, a processing unit 1104, and a determining unit 1106.

The obtaining unit 1102 is configured to: obtain a plurality of pieces of relationship data between a specified codec performance metric and a bitrate, the relationship data including a bitrate value and a value of the specified codec performance metric corresponding to the bitrate value; and obtain a monotonic target function set for the specified codec performance metric and the bitrate, the target function including a plurality of parameters for representing a shape of a function curve. The processing unit 1104 is configured to solve values of the plurality of parameters based on the plurality of pieces of relationship data and the target function. The determining unit 1106 is configured to determine a nonlinear relationship between the specified codec performance metric and the bitrate based on the target function and the values of the plurality of parameters.

In some embodiments of this application, based on the foregoing solutions, the obtaining unit 1102 is configured to: encode reference multimedia data separately by using a plurality of encoding parameters, to obtain encoded data corresponding to each encoding parameter; generate, based on an obtained bitrate statistic of each piece of encoded data and the value of the specified codec performance metric, relationship data corresponding to each piece of encoded data; and use the relationship data corresponding to each piece of encoded data as the plurality of pieces of relationship data.

In some embodiments of this application, based on the foregoing solutions, the processing unit 1104 is configured to: initialize the values of the plurality of parameters based on the plurality of pieces of relationship data, to obtain initial values of the plurality of parameters; and fit the target function based on the initial values of the plurality of parameters and the plurality of pieces of relationship data, to obtain the values of the plurality of parameters through solving.

In some embodiments of this application, based on the foregoing solutions, the plurality of parameters include at least one of the following parameters: a first parameter for representing a maximum output value of the target function, a second parameter for representing a minimum output value of the target function, a third parameter for representing a translation amount of a function curve corresponding to the target function on a bitrate coordinate axis, and a fourth parameter for representing an intensity of variation of the function curve within a linear interval.

In some embodiments of this application, based on the foregoing solutions, a maximum value of the specified codec performance metric in the plurality of pieces of relationship data is used as an initial value of the first parameter; a minimum value of the specified codec performance metric in the plurality of pieces of relationship data is used as an initial value of the second parameter; an average value of the bitrate values included in the plurality of pieces of relationship data is used as an initial value of the third parameter; and a standard deviation of the bitrate values included in the plurality of pieces of relationship data is used as an initial value of the fourth parameter.

In some embodiments of this application, based on the foregoing solutions, a process of the processing unit 1104 performing fitting processing on the target function based on the initial values of the plurality of parameters and the plurality of pieces of relationship data, to obtain the values of the plurality of parameters through solving includes any one of the following manners: fitting the target function through the Newton method based on the initial values of the plurality of parameters and the plurality of pieces of relationship data, to obtain the values of the plurality of parameters through solving; fitting the target function through the quasi-Newton method based on the initial values of the plurality of parameters and the plurality of pieces of relationship data, to obtain the values of the plurality of parameters through solving; fitting the target function through an evolution method based on the initial values of the plurality of parameters and the plurality of pieces of relationship data, to obtain the values of the plurality of parameters through solving; and fitting the target function through a gradient descent method based on the initial values of the plurality of parameters and the plurality of pieces of relationship data, to obtain the values of the plurality of parameters through solving.

In some embodiments of this application, based on the foregoing solutions, the plurality of pieces of relationship data between the specified codec performance metric and the bitrate include a plurality of pieces of relationship data corresponding to a baseline codec and a plurality of pieces of relationship data corresponding to a test codec. The determining unit 1106 is configured to: determine, based on the target function and the values of the plurality of parameters obtained through solving based on the plurality of pieces of relationship data corresponding to the baseline codec, a first nonlinear relationship between the specified codec performance metric and the bitrate corresponding to the baseline codec; and determine, based on the target function and the values of the plurality of parameters obtained through solving based on the plurality of pieces of relationship data corresponding to the test codec, a second nonlinear relationship between the specified codec performance metric and the bitrate corresponding to the test codec.

In some embodiments of this application, based on the foregoing solutions, the apparatus 1100 for processing a codec performance metric further includes a calculation unit, configured to: calculate, based on the first nonlinear relationship, the second nonlinear relationship, and a set bitrate interval, an average gain of the specified codec performance metric of the test codec relative to the baseline codec under the same bitrate condition.

In some embodiments of this application, based on the foregoing solutions, the calculation unit is configured to: calculate, based on the first nonlinear relationship and the set bitrate interval, a first integral area of a function curve corresponding to the first nonlinear relationship within the set bitrate interval; calculate, based on the second nonlinear relationship and the set bitrate interval, a second integral area of a function curve corresponding to the second nonlinear relationship within the set bitrate interval; calculate an area difference between the second integral area and the first integral area; and calculate, based on the area difference and the bitrate interval, the average gain of the specified codec performance metric of the test codec relative to the baseline codec under the same bitrate condition.

In some embodiments of this application, based on the foregoing solutions, the apparatus 1100 for processing a codec performance metric further includes a calculation unit, configured to: calculate, based on the first nonlinear relationship, the second nonlinear relationship, and a set specified codec performance metric interval, an average bitrate gain of the test codec relative to the baseline codec under the same specified codec performance metric condition.

In some embodiments of this application, based on the foregoing solution, the calculation unit is configured to calculate, based on the first nonlinear relationship and the set specified codec performance metric interval, a third integral area of a function curve corresponding to the first nonlinear relationship within the set specified codec performance metric interval; calculate, based on the second nonlinear relationship and the set specified codec performance metric interval, a fourth integral area of a function curve corresponding to the second nonlinear relationship within the set specified codec performance metric interval; calculate an area difference between the fourth integral area and the third integral area; and calculate, based on the area difference and the set specified codec performance metric interval, the average bitrate gain of the test codec relative to the baseline codec under the same specified codec performance metric condition.

In some embodiments of this application, based on the foregoing solutions, the specified codec performance metric includes at least one of the following: a peak signal to noise ratio, mean average precision, multiple objects tracking accuracy, encoding time, and decoding time.

FIG. 12 is a schematic structural diagram of a computer system suitable for implementing the electronic device according to the embodiments of this application.

A computer system 1200 of the electronic device shown in FIG. 12 is merely an example, and does not limit functions and the scope of usage of embodiments of this application.

As shown in FIG. 12, the computer system 1200 may include a central processing unit (CPU) 1201, and the central processing unit may perform various appropriate actions and processes based on a program stored in a read-only memory (ROM) 1202 or a program loaded to a random access memory (RAM) 1203 from a storage part 1208, for example, perform the method of the foregoing embodiments. Various programs and data needed for a system operation are stored in the RAM 1203. The CPU 1201, the ROM 1202, and the RAM 1203 are connected through a bus 1204. An input/output (I/O) 1205 is connected to the bus 1204.

The following components may be connected to the I/O interface 1205, including an input part 1206 of a keyboard, a mouse, and the like; including an input part 1207 of a cathode ray tube (CRT), a liquid crystal display (LCD), a speaker, and the like; including a storage part 1208 of hardware; and including a communication part 1209 of a network interface card such as a local area network (LAN) card, a modem, and the like. The communication part 1209 performs communication processing via a network such as the Internet. A driver 1210 is also connected to the I/O interface 1205 as needed. A removable media 1211, such as a magnetic disk, an optical disk, a magneto-optical disk, a semiconductor memory, and the like are installed on the drive 1210 as needed, so that it may be read that a computer program is installed to the storage part 1208 as needed.

Specifically, based on embodiments of this application, the process described foregoing with reference to the flowchart may be implemented as a computer software program. For example, an embodiment of this application includes a computer program product, and the computer program product is carried on computer program of a non-transitory computer-readable medium. The computer program is configured to perform the method shown in the flowchart. In this embodiment, the computer program may be uploaded and installed from the network by using the communication part 1209, and/or be installed from the removable media 1211. When the computer program is executed by the central processing unit (CPU) 1201, various functions limited in a system of this application are executed.

According to another aspect, this application further provides a non-transitory computer-readable medium. The computer-readable medium may be included in the electronic device described in embodiments, and may also exist alone without being assembled into the electronic device. The computer-readable medium carries one or more computer programs. When the one or more computer programs are executed by the electronic device, the electronic device implements the method described in the foregoing embodiments.

Although several modules or units of the device for action execution are mentioned in the foregoing detailed description, this division is not mandatory. Actually, based on the embodiments of this application, features and functions of two or more modules or units described above may be specified in one module or unit. On the contrary, the features and the functions of one module or unit described above may be further divided that is specified in one module or unit.

Through the foregoing description of the implementations, a person skilled in the art can easily understand that example embodiments described here may be implemented by software, or may be implemented by software combined with necessary hardware. Therefore, the technical solutions based on embodiments of this application may be implemented in a form of a software product. The software product may be stored in a non-volatile storage media (may be a CD-ROM, a USB flash disk, a hard disk, and the like) or on the network, including several instructions, so that an electronic device executes the method in the embodiments of this application. For example, the electronic device may perform the method for processing codec performance metric shown in FIG. 5.

A person skilled in the art can easily figure out another implementation solution of the implementation, the after considering the specification and practicing this application that is disclosed herein. This application is intended to cover any variations, uses or adaptive changes of this application. Such variations, uses or adaptive changes follow the general principles of this application, and include well-known knowledge and conventional technical means in the art that are not disclosed in this application.

This application is not limited to the precise structures described above and shown in the accompanying drawings, and various modifications and changes can be made without departing from the scope of this application. The scope of this application is subject only to the appended claims.

What is claimed is:

1. A method for processing a codec performance metric performed by an electronic device, the method comprising:
obtaining a plurality of pieces of relationship data between a specified codec performance metric and a bitrate;
obtaining a monotonic target function set for the specified codec performance metric and the bitrate, the target function comprising a plurality of parameters for representing a shape of a function curve;
determining the plurality of parameters based on the plurality of pieces of relationship data and the target function; and
determining a nonlinear relationship between the specified codec performance metric and the bitrate based on the target function and the plurality of parameters.

2. The method according to claim 1, wherein the obtaining a plurality of pieces of relationship data between a specified codec performance metric and a bitrate comprises:
encoding reference multimedia data separately by using a plurality of encoding parameters, to obtain encoded data corresponding to each encoding parameter; and
generating relationship data corresponding to each piece of encoded data as a corresponding one of the plurality of pieces of relationship data.

3. The method according to claim 1, wherein the determining the plurality of parameters based on the plurality of pieces of relationship data and the target function comprises:
initializing the plurality of parameters based on the plurality of pieces of relationship data, to obtain initial values of the plurality of parameters; and
fitting the target function based on the initial values of the plurality of parameters and the plurality of pieces of relationship data, to obtain the plurality of parameters through solving.

4. The method according to claim 1, wherein the plurality of parameters comprises at least one of the following parameters:
a first parameter for representing a maximum output value of the target function, a second parameter for representing a minimum output value of the target function, a third parameter for representing a translation amount of a function curve corresponding to the target function on a bitrate coordinate axis, and a fourth parameter for representing an intensity of variation of the function curve within a linear interval.

5. The method according to claim 1, wherein the plurality of pieces of relationship data between the specified codec performance metric and the bitrate comprise a plurality of pieces of relationship data corresponding to a baseline codec and a plurality of pieces of relationship data corresponding to a test codec; and
the determining the nonlinear relationship between the specified codec performance metric and the bitrate based on the target function and the values of the plurality of parameters comprises:
determining, based on the target function and the values of the plurality of parameters obtained through solving based on the plurality of pieces of relationship data corresponding to the baseline codec, a first nonlinear relationship between the specified codec performance metric and the bitrate corresponding to the baseline codec; and
determining, based on the target function and the values of the plurality of parameters obtained through solving based on the plurality of pieces of relationship data corresponding to the test codec, a second nonlinear relationship between the specified codec performance metric and the bitrate corresponding to the test codec.

6. The method according to claim 5, wherein the method further comprises:
calculating, based on the first nonlinear relationship, the second nonlinear relationship, and a set bitrate interval, an average gain of the specified codec performance metric of the test codec relative to the baseline codec under the same bitrate condition.

7. The method according to claim 5, wherein the method further comprises:
calculating, based on the first nonlinear relationship, the second nonlinear relationship, and a set specified codec performance metric interval, an average bitrate gain of the test codec relative to the baseline codec under the same specified codec performance metric condition.

8. The method according to claim 1, wherein the specified codec performance metric comprises at least one of the following: a peak signal to noise ratio, mean average precision, multiple objects tracking accuracy, encoding time, and decoding time.

9. An electronic device, comprising
one or more processors; and
a memory, configured to store one or more computer programs, the one or more computer programs, when executed by the one or more processors, causing the electronic device to implement a method for processing a codec performance metric including:
obtaining a plurality of pieces of relationship data between a specified codec performance metric and a bitrate;
obtaining a monotonic target function set for the specified codec performance metric and the bitrate, the target function comprising a plurality of parameters for representing a shape of a function curve;
determining the plurality of parameters based on the plurality of pieces of relationship data and the target function; and
determining a nonlinear relationship between the specified codec performance metric and the bitrate based on the target function and the plurality of parameters.

10. The electronic device according to claim 9, wherein the obtaining a plurality of pieces of relationship data between a specified codec performance metric and a bitrate comprises:
encoding reference multimedia data separately by using a plurality of encoding parameters, to obtain encoded data corresponding to each encoding parameter; and
generating relationship data corresponding to each piece of encoded data as a corresponding one of the plurality of pieces of relationship data.

11. The electronic device according to claim 9, wherein the determining the plurality of parameters based on the plurality of pieces of relationship data and the target function comprises:
initializing the plurality of parameters based on the plurality of pieces of relationship data, to obtain initial values of the plurality of parameters; and
fitting the target function based on the initial values of the plurality of parameters and the plurality of pieces of relationship data, to obtain the plurality of parameters through solving.

12. The electronic device according to claim 9, wherein the plurality of parameters comprises at least one of the following parameters:
a first parameter for representing a maximum output value of the target function, a second parameter for representing a minimum output value of the target function, a third parameter for representing a translation amount of a function curve corresponding to the target function on a bitrate coordinate axis, and a fourth parameter for representing an intensity of variation of the function curve within a linear interval.

13. The electronic device according to claim 9, wherein the plurality of pieces of relationship data between the specified codec performance metric and the bitrate comprise a plurality of pieces of relationship data corresponding to a baseline codec and a plurality of pieces of relationship data corresponding to a test codec; and
the determining the nonlinear relationship between the specified codec performance metric and the bitrate based on the target function and the values of the plurality of parameters comprises:
determining, based on the target function and the values of the plurality of parameters obtained through solving based on the plurality of pieces of relationship data corresponding to the baseline codec, a first nonlinear relationship between the specified codec performance metric and the bitrate corresponding to the baseline codec; and
determining, based on the target function and the values of the plurality of parameters obtained through solving based on the plurality of pieces of relationship data corresponding to the test codec, a second nonlinear relationship between the specified codec performance metric and the bitrate corresponding to the test codec.

14. The electronic device according to claim 13, wherein the method further comprises:
calculating, based on the first nonlinear relationship, the second nonlinear relationship, and a set bitrate interval, an average gain of the specified codec performance metric of the test codec relative to the baseline codec under the same bitrate condition.

15. The electronic device according to claim 13, wherein the method further comprises:
calculating, based on the first nonlinear relationship, the second nonlinear relationship, and a set specified codec performance metric interval, an average bitrate gain of the test codec relative to the baseline codec under the same specified codec performance metric condition.

16. A non-transitory computer-readable medium having a computer program stored therein, the computer program, when executed by a processor of an electronic device, causing the electronic device to implement a method for processing a codec performance metric including:
obtaining a plurality of pieces of relationship data between a specified codec performance metric and a bitrate;
obtaining a monotonic target function set for the specified codec performance metric and the bitrate, the target function comprising a plurality of parameters for representing a shape of a function curve;
determining the plurality of parameters based on the plurality of pieces of relationship data and the target function; and
determining a nonlinear relationship between the specified codec performance metric and the bitrate based on the target function and the plurality of parameters.

17. The non-transitory computer-readable medium according to claim 16, wherein the obtaining a plurality of pieces of relationship data between a specified codec performance metric and a bitrate comprises:
encoding reference multimedia data separately by using a plurality of encoding parameters, to obtain encoded data corresponding to each encoding parameter; and
generating relationship data corresponding to each piece of encoded data as a corresponding one of the plurality of pieces of relationship data.

18. The non-transitory computer-readable medium according to claim 16, wherein the determining the plurality of parameters based on the plurality of pieces of relationship data and the target function comprises:
initializing the plurality of parameters based on the plurality of pieces of relationship data, to obtain initial values of the plurality of parameters; and
fitting the target function based on the initial values of the plurality of parameters and the plurality of pieces of relationship data, to obtain the plurality of parameters through solving.

19. The non-transitory computer-readable medium according to claim 16, wherein the plurality of parameters comprises at least one of the following parameters:
a first parameter for representing a maximum output value of the target function, a second parameter for representing a minimum output value of the target function, a third parameter for representing a translation amount of a function curve corresponding to the target function on a bitrate coordinate axis, and a fourth parameter for representing an intensity of variation of the function curve within a linear interval.

20. The non-transitory computer-readable medium according to claim 16, wherein the plurality of pieces of relationship data between the specified codec performance metric and the bitrate comprise a plurality of pieces of relationship data corresponding to a baseline codec and a plurality of pieces of relationship data corresponding to a test codec; and
the determining the nonlinear relationship between the specified codec performance metric and the bitrate based on the target function and the values of the plurality of parameters comprises:
determining, based on the target function and the values of the plurality of parameters obtained through solving based on the plurality of pieces of relationship data corresponding to the baseline codec, a first nonlinear relationship between the specified codec performance metric and the bitrate corresponding to the baseline codec; and
determining, based on the target function and the values of the plurality of parameters obtained through solving based on the plurality of pieces of relationship data corresponding to the test codec, a second nonlinear relationship between the specified codec performance metric and the bitrate corresponding to the test codec.
